(19) United States
(12) Patent Application Publication
(10) Pub. No.: US 2014/0177967 A1
(43) Pub. Date: Jun. 26, 2014

(54) EMOTION INFORMATION CONVERSION APPARATUS AND METHOD

(71) Applicants: Myongji University Industry and Academia Cooperation Foundation, Yongin-si Gyeonggi-do (KR); Electronics and Telecommunications Research Institute, Daejeon (KR)

(72) Inventors: Seung Jun YANG, Daejeon (KR); Sang Kyun KIM, Seongnam-si Gyeonggi-do (KR); Yong Soo JOO, Seoul (KR)

(73) Assignees: Myongji University Industry and Academia Cooperation Foundation, Yongin-si Gyeonggi-do (KR); Electronics and Telecommunications Research Institute, Daejeon (KR)

(21) Appl. No.: 14/141,171

(22) Filed: Dec. 26, 2013

(30) Foreign Application Priority Data
Dec. 26, 2012 (KR) 10-2012-0153120

(51) Int. Cl. G06K 9/00

(52) U.S. Cl. CPC G06K 9/00302
USPC 382/195

(57) ABSTRACT

An emotion information conversion apparatus and method is provided. The emotion information conversion apparatus includes a visual information extractor to extract visual information from an input image, an emotion information converter to analyze the extracted visual information and convert the visual information into emotion information, and a sensory effect information generator to generate sensory effect information transferable to a user, based on the converted emotion information.

### CROSS-REFERENCE TO RELATED APPLICATION

This application claims the benefit of Korean Patent Application No. 10-2012-0153120, filed on Dec. 26, 2012, in the Korean Intellectual Property Office, the disclosure of which is incorporated herein by reference.

### BACKGROUND

1. Field of the Invention

The present invention relates to an emotion information conversion apparatus and method, and more particularly, to an emotion information conversion apparatus and method that may generate sensory effect information that is transferable to a user, using visual information extracted from an input image.

2. Description of the Related Art

In the past, media using a sense of sight and an auditory sense was dominant. However, four-dimensional (4D) media providing sensory effects, for example, a tactile sense, an olfactory sense, and the like, in addition to a sense of sight and an auditory sense, have been recently invigorated. The 4D media may add sensory effects to a two-dimensional (2D) image or a three-dimensional (3D) image. The sensory effects may include vibration of a chair, wind, vapor, scent, lighting effects, and the like. The 4D media may present images more effectively, when compared to conventional media. In particular, the 4D media may provide realistic images to the user by stimulating five senses of the user. In this instance, the 4D media may perform a process of producing and generating sensory effect information with respect to media contents.

However, a method of describing and producing sensory effects which stimulate the five senses of the user may be cost-inefficient. In particular, the method of producing the sensory effects may manually produce sensory effects corresponding to scenes by analyzing main scenes of the media contents and thus, a great amount of time and cost may be used for production.

Accordingly, there is a demand for a method of producing sensory effects more efficiently.

### SUMMARY

An aspect of the present invention provides an emotion information conversion apparatus and method that may extract emotion information corresponding to visual information of an image, and automatically generate sensory effect information corresponding to the emotion information, thereby generating sensory effect information more conveniently and effectively, when compared to a conventional manual method.

Another aspect of the present invention also provides an emotion information conversion apparatus and method that may automatically generate sensory effect information, thereby minimizing an amount of time and cost to be used for generating the sensory effect information.

According to an aspect of the present invention, there is provided an emotion information conversion apparatus, including a visual information extractor to extract visual information from an input image, an emotion information converter to analyze the extracted visual information and convert the visual information into emotion information, and a sensory effect information generator to generate sensory effect information transferable to a user, based on the converted emotion information.

The visual information extractor may extract visual information corresponding to motion information of an object in the image or motion information of the entire image, using a vector or a blur of the image.

The visual information extractor may extract visual information corresponding to a change in a color of the image, using characteristic information related to the color of the image.

The sensory effect information generator may evaluate an applicability and an effectiveness of the emotion information, and perform filtering to convert the emotion information into the sensory effect information.

The sensory effect information generator may generate sensory effect supplementary data to be used to express the sensory effect information.

The sensory effect information generator may generate a sensory effect reproduction control signal to be used to control a sensory effect reproduction apparatus, and the sensory effect reproduction control signal may be reproduced based on the sensory effect information.

According to another aspect of the present invention, there is also provided an emotion information conversion method, including extracting visual information from an input image, analyzing the extracted visual information and converting the visual information into emotion information, and generating sensory effect information transferable to a user, based on the converted emotion information.

The extracting may include extracting visual information corresponding to motion information of an object in the image or motion information of the entire image, using a vector or a blur of the image.

The extracting may include extracting visual information corresponding to a change in a color of the image, using characteristic information related to the color of the image.

The generating may include evaluating an applicability and an effectiveness of the emotion information, and performing filtering to convert the emotion information into the sensory effect information.

The generating may include generating sensory effect supplementary data to be used to express the sensory effect information.

The generating may include generating a sensory effect reproduction control signal to be used to control a sensory effect reproduction apparatus, and the sensory effect reproduction control signal may be reproduced based on the sensory effect information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an emotion information conversion apparatus according to an embodiment of the present invention;

FIG. 2 is a block diagram illustrating a detailed configuration of an emotion information conversion apparatus according to an embodiment of the present invention; and

FIG. 3 is a flowchart illustrating an emotion information conversion method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

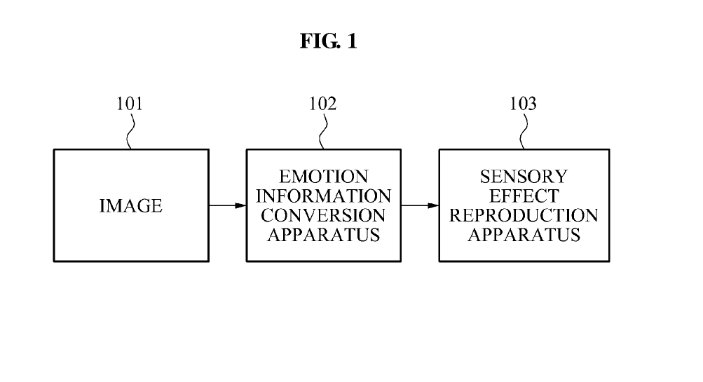

FIG. 1 is a block diagram illustrating an emotion information conversion apparatus 102 according to an embodiment of the present invention.

Referring to FIG. 1, the emotion information conversion apparatus 102 may receive an input of an image 101. The emotion information conversion apparatus 102 may extract visual information from the input image 101. The visual information may include a change in a color, a motion of an object included in the image 101, and the like. Accordingly, the emotion information conversion apparatus 102 may extract visual information, for example, a change in a color, a motion of an object included in the image 101, and the like.

The emotion information conversion apparatus 102 may generate sensory effect information that is transferable to a user, using the extracted visual information. The sensory effect information may refer to information converted based on whether emotion information converted based on the visual information is applicable. In addition, the sensory effect information may be used to generate a sensory effect reproduction control signal and sensory effect supplementary data. Here, the sensory effect supplementary data may correspond to various representation schemes to be used to express sensory effects based on the sensory effect information. The sensory effect reproduction control signal may refer to a signal to be used to control a sensory effect reproduction apparatus 103 capable of reproducing sensory effects based on the sensory effect information.

The sensory effect reproduction apparatus 103 may control a function related to the sensory effects, based on the received sensory effect reproduction control signal. In this instance, the sensory effect reproduction apparatus 103 may include at least one device. The sensory effect reproduction apparatus 103 may perform different functions for expressing the sensory effects. In addition, the sensory effect reproduction apparatus 103 may refer to an apparatus capable of stimulating five senses of the user, using the sensory effect information for expressing the image 101 more effectively based on the visual information of the image 101.

The emotion information conversion apparatus 102 may extract emotion information corresponding to visual information of the image 101, and automatically generate sensory effect information corresponding to the emotion information, thereby generating sensory effect information more conveniently and efficiently, when compared to a conventional manual method.

In addition, the emotion information conversion apparatus 102 may automatically generate sensory effect information, thereby minimizing an amount of time and cost to be used for generating the sensory effect information.

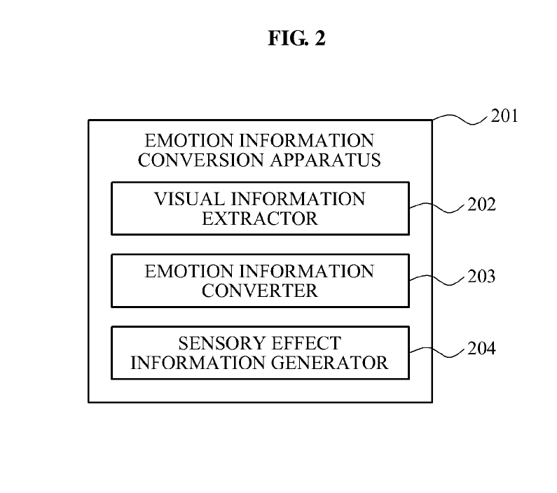

FIG. 2 is a block diagram illustrating a detailed configuration of an emotion information conversion apparatus 201 according to an embodiment of the present invention.

Referring to FIG. 2, the emotion information conversion apparatus 201 may include a visual information extractor 202, an emotion information converter 203, and a sensory effect information generator 204.

The visual information extractor 202 may extract visual information from an input image. For example, the input image may correspond to a color image, or a depth image. The visual information may include a color temperature, a change in a color, a motion blur, a motion vector of an object included in the color image, and the like. In addition, the visual information may include a characteristic value of the image. Here, the characteristic value of the image may include a brightness, a chroma, a color of the color image, and the like. When the input image corresponds to a depth image, the visual information may include a disparity vector, a depth value, and the like. The image may refer to a decoded image including frame units. The image may include a moving image, a still image, and the like.

The visual information extractor 202 may extract visual information using a blur or a vector of the image. As an example, the visual information extractor 202 may extract visual information corresponding to motion information of the entire color image or motion information of an object in the color image. The visual information extractor 202 may employ a variety of algorithms for extracting the visual information. In particular. The visual information extractor 202 may extract motion information including a motion direction, a shake in the entire image, and the like, or motion information of the object, using extraction algorithms, for example, a motion vector, a motion blur, and the like. As another example, when the input image corresponds to a depth image, the visual information extractor 202 may extract visual information including a depth value or a disparity vector, using extraction algorithms, for example, the disparity vector, the depth value, and the like. Depth values may be converted into a tactile sense related to the emotion information, and utilized for the visually impaired.

The visual information extractor 202 may extract visual information corresponding to a change in a color of the image. For example, when the input image corresponds to a color image, the visual information extractor 202 may extract characteristic information related to a color of the image, using extraction algorithms that extract, for example, a color histogram, a color structure, a dominant color, a color temperature, and the like. In particular, the visual information extractor 202 may extract the visual information corresponding to the change in the color of the image, using the characteristic information related to the color of the image.

The visual information extractor 202 may extract visual information related to the emotion information corresponding to the change in the color and a motion in the image.

The emotion information converter 203 may analyze the extracted visual information and convert the visual information into emotion information. The emotion information converter 203 may analyze the extracted visual information corresponding to low data. The emotion information converter 203 may analyze the visual information, based on the visual information related to the color or visual information related to a motion. For example, the emotion information converter 203 may analyze the visual information based on a lateral shake of the entire image, and analyze the visual information based on reddish color information.

The emotion information converter 203 may convert the analyzed visual information into applicable emotion information. In this instance, the emotion information may correspond to applicable refined data, in particular, applicable information that may be mapped to the visual information related to the color or the visual information related to the motion. For example, the emotion information converter 203 may convert the visual information into emotion information with a warm feeling based on the reddish color information.

The sensory effect information generator 204 may determine whether the converted emotion information is applicable. The sensory effect information generator 204 may evaluate an applicability and an effectiveness of the emotion information. The sensory effect information generator 204 may evaluate the emotion information, and perform filtering to convert applicable information into sensory effects. In particular, the sensory effect information generator 204 may evaluate and filter the emotion information before the emotion information is converted into sensory effect information.

The sensory effect information generator 204 may convert the filtered applicable emotion information into the sensory effect information. For example, the sensory effect information generator 204 may receive emotion information converted to have a warm feeling based on visual information related to a color temperature. The sensory effect information generator 204 may convert the emotion information into sensory effect information that may express the warm feeling of the transferred emotion information. Here, the sensory effect information may correspond to, for example, a light effect, a temperature effect, and the like.

The sensory effect information generator 204 may generate a sensory effect reproduction control signal or sensory effect supplementary data, based on the converted sensory effect information.

The sensory effect supplementary data may correspond to data of various representation schemes to be used to express sensory effect information effectively. In this instance, the sensory effect supplementary data may be used to express the sensory effect information effectively using an extensible mark-up language (XML), and the like.

The sensory effect reproduction control signal may refer to a signal to be used to control a sensory effect reproduction apparatus capable of reproducing sensory effect information. In particular, the sensory effect reproduction control signal may be transferred to the sensory effect reproduction apparatus capable of reproducing different effects based on the sensory effect information. For example, the emotion information conversion apparatus 201 may generate sensory effect information corresponding to, for example, an effect of warm wind, an effect of temperature increase, and the like, based on emotion information with a warm feeling. The emotion information conversion apparatus 201 may generate a sensory effect reproduction control signal to be used to express the generated sensory effect information. In this instance, the emotion information conversion apparatus 201 may generate a sensory effect reproduction control signal to be used to control a fan heater, a temperature control system, and the like, based on the sensory effect information.

As another example, the emotion information conversion apparatus 201 may generate sensory effect information corresponding to, for example, an effect of speed increase, an effect of impact, and the like, based on motion information of a shaking object. The emotion information conversion apparatus 201 may generate sensory effect information corresponding to, for example, a wind effect, an effect of a chair shake, an effect of a chair impact, and the like. The emotion information conversion apparatus 201 may generate a sensory effect reproduction control signal to be used to reproduce the sensory effect information corresponding to the wind effect, the effect of the chair shake, the effect the chair impact, and the like. The emotion information conversion apparatus 201 may generate a sensory effect reproduction control signal to be used to control an electric fan, a chair control system, and the like, based on the sensory effect information. In this instance, the chair control system may refer to a system capable of controlling a chair to provide effects similar to conditions, for example, a shake, an impact, and the like, based on the sensory effect information.

The emotion information conversion apparatus 201 may transfer the generated sensory effect reproduction control signal to the sensory effect reproduction apparatus.

The emotion information conversion apparatus 201 may automatically extract sensory effect information from an input image, thereby readily generating a sensory effect reproduction control signal or sensory effect supplementary data corresponding to the sensory effect information.

In addition, the emotion information conversion apparatus 201 may generate sensory effect information more conveniently and efficiently, thereby increasing a convenience and an efficiency of production of sensory effect information.

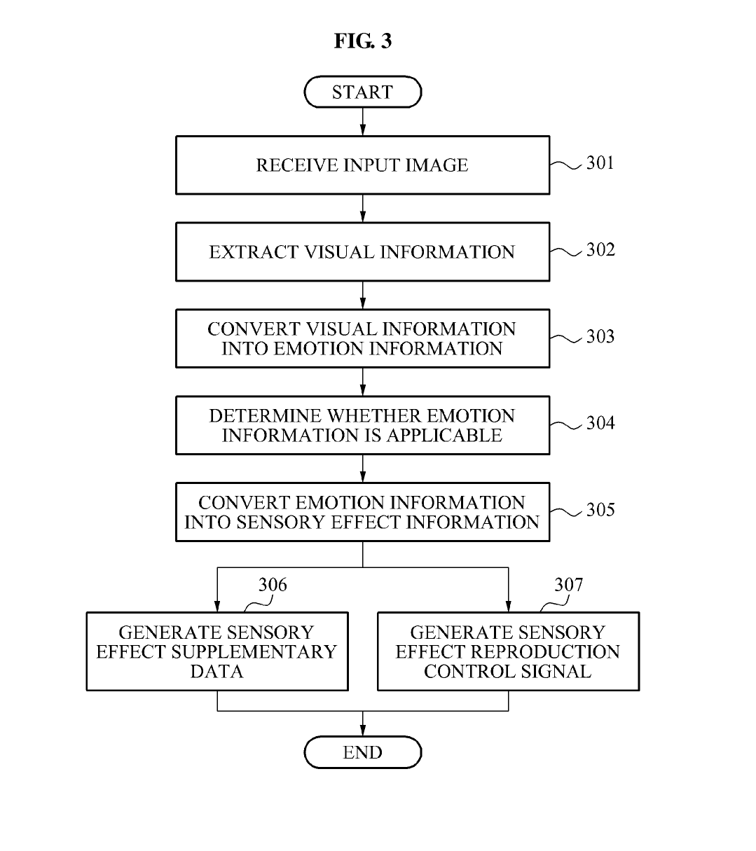

FIG. 3 is a flowchart illustrating an emotion information conversion method according to an embodiment of the present invention. The emotion information conversion method may be performed by an emotion information conversion apparatus.

Referring to FIG. 3, in operation 301, an input of an image, for example, a moving image or a still image, may be received. In this instance, the image may refer to a decoded image including frame units.

In operation 302, visual information may be extracted from the input image. The visual information may include a change in a color, a motion of an object included in the image, and the like. Motion information including a motion direction, a shake in the entire image, and the like, or motion information of the object may be extracted using extraction algorithms, for example, a motion vector, a motion blur, and the like. In addition, characteristic information related to a color of the image may be extracted using extraction algorithms that extract, for example, a color histogram, a color structure, a dominant color, a color temperature, and the like.

In particular, the visual information corresponding to the change in the color of the image may be extracted using the characteristic information related to the color of the image. Also, a variety of algorithms may be employed to extract visual information, and such algorithms are not to be limited to the aforementioned extraction algorithms.

In operation 303, the extracted visual information may be analyzed and converted into emotion information. In particular, the visual information may be analyzed based on the visual information related to the color or visual information related to a motion. The analyzed visual information may be converted into applicable emotion information.

In operation 304, whether the converted emotion information is applicable may be determined. An applicability and an effectiveness of the emotion information may be evaluated, and filtering may be performed to convert the applicable emotion information into sensory effects.

In operation 305, the filtered applicable emotion information may be converted into sensory effect information. In particular, the emotion information converted based on the visual information may be filtered as the applicable emotion information, and converted into sensory effect information that is transferable to a user. A sensory effect reproduction control signal or sensory effect supplementary data may be generated based on the converted sensory effect information.

In operation 306, sensory effect supplementary data to be used to express the sensory effect information effectively may be generated using an XML, and the like.

In operation 307, a sensory effect reproduction control signal to be used to control a sensory effect reproduction apparatus capable of reproducing sensory effect information may be generated. In particular, the sensory effect reproduction control signal may be transferred to the sensory effect reproduction apparatus capable of reproducing different effects based on the sensory effect information.

The above-described method according to the exemplary embodiments of the present invention may be recorded in non-transitory computer-readable media including program instructions to implement various operations embodied by a computer. The non-transitory computer-readable media may also include, alone or in combination with the program instructions, data files, data structures, and the like. The media and program instructions may be those specially designed and constructed for the purposes of the present invention, or they may be of the kind well-known and available to those having skill in the computer software arts.

According to an embodiment of the present invention, an emotion information conversion apparatus and method may extract emotion information corresponding to visual information of an image, and automatically generate sensory effect information corresponding to the emotion information, thereby generating sensory effect information more conveniently and effectively, when compared to a conventional manual method.

According to an embodiment of the present invention, an emotion information conversion apparatus and method may automatically generate sensory effect information, thereby minimizing an amount of time and cost to be used for generating the sensory effect information.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

Accordingly, the invention is not limited to such embodiments, but rather to the broader scope of the presented claims and various obvious modifications and equivalent arrangements.

What is claimed is:

1. An emotion information conversion apparatus, comprising:
a visual information extractor to extract visual information from an input image;
an emotion information converter to analyze the extracted visual information and convert the visual information into emotion information; and
a sensory effect information generator to generate sensory effect information transferable to a user, based on the converted emotion information.

2. The apparatus of claim 1, wherein the visual information extractor extracts visual information corresponding to motion information of an object in the image or motion information of the entire image, using a vector or a blur of the image.

3. The apparatus of claim 1, wherein the visual information extractor extracts visual information corresponding to a change in a color of the image, using characteristic information related to the color of the image.

4. The apparatus of claim 1, wherein the sensory effect information generator evaluates an applicability and an effectiveness of the emotion information, and performs filtering to convert the emotion information into the sensory effect information.

5. The apparatus of claim 1, wherein the sensory effect information generator generates sensory effect supplementary data to be used to express the sensory effect information.

6. The apparatus of claim 1, wherein the sensory effect information generator generates a sensory effect reproduction control signal to be used to control a sensory effect reproduction apparatus,
wherein the sensory effect reproduction control signal is reproduced based on the sensory effect information.

7. An emotion information conversion method, comprising:
extracting visual information from an input image;
analyzing the extracted visual information and converting the visual information into emotion information; and
generating sensory effect information transferable to a user, based on the converted emotion information.

8. The method of claim 7, wherein the extracting comprises extracting visual information corresponding to motion information of an object in the image or motion information of the entire image, using a vector or a blur of the image.

9. The method of claim 7, wherein the extracting comprises extracting visual information corresponding to a change in a color of the image, using characteristic information related to the color of the image.

10. The method of claim 7, wherein the generating comprises evaluating an applicability and an effectiveness of the emotion information, and performing filtering to convert the emotion information into the sensory effect information.

11. The method of claim 7, wherein the generating comprises generating sensory effect supplementary data to be used to express the sensory effect information.

12. The method of claim 7, wherein the generating comprises generating a sensory effect reproduction control signal to be used to control a sensory effect reproduction apparatus,
wherein the sensory effect reproduction control signal is reproduced based on the sensory effect information.
